(19) United States
(12) Patent Application Publication
(10) Pub. No.: US 2022/0109470 A1
(43) Pub. Date: Apr. 7, 2022

(54) WIRELESS COMMUNICATION SYSTEM AND RECEPTION APPARATUS

(71) Applicant: CANON KABUSHIKI KAISHA, Tokyo (JP)

(72) Inventor: Hiroto Tamaki, Saitama (JP)

(21) Appl. No.: 17/488,460

(22) Filed: Sep. 29, 2021

(30) Foreign Application Priority Data
Oct. 7, 2020 (JP) 2020-170032

(51) Int. Cl. H04B 5/00

(52) U.S. Cl. CPC H04B 5/0031; H04B 5/0018; H04B 5/0012

(57) ABSTRACT

A wireless communication system operable to transmit a signal using an electric field coupling that is caused by a transmission coupler provided in a first apparatus being arranged close to a reception coupler provided in a second apparatus, wherein the second apparatus has a reception circuit that is connected to the reception coupler, and the reception circuit, in a case where a coupling capacitance between the transmission coupler and the reception coupler is C and a basic angular frequency of the signal is ω, has a termination resistor that is larger than 10/ωC.

### BACKGROUND OF THE INVENTION

### Field of the Invention

The present invention relates to a technique for transmitting a plurality of types of signals.

### Description of the Related Art

Usually, a harness or a cable is used as a connection means between communication interfaces in a plurality of modules or a plurality of electronic devices. By making the portion where harnesses and cables are used wireless, there is an advantage that the assemblability of the product is improved or the automization of the manufacturing process is facilitated.

Japanese Patent Laid-Open No. 2016-29785 (hereinafter, Patent Literature 1) discloses a wireless communication system for contactlessly transmitting digital signals, “1” and “0”, using electric field coupling. In Patent Literature 1, wireless communication is realized using electric field coupling caused by couplers that are provided in each of transmitter/receiver which face and are arranged close to each other. Electric field coupling has a characteristic similar to that of an HPF (high-pass filter) in which the degree of coupling is weak in a low frequency band and the degree of coupling is strong in a high frequency band. Therefore, when a termination resistor of a circuit immediately after the coupler of the receiver side is set to 50Ω as in Patent Literature 1, the waveform generated in the coupler of the receiver side will be an imperfect differential waveform as described in Patent Literature 1. In Patent Literature 1, wireless communication is performed by a hysteresis circuit (comparator circuit that has a threshold) shaping this imperfect differential waveform to the digital signals, “1” and “0”.

Meanwhile, USB (Universal Serial Bus) interfaces, which are one of the communication standards, have become widespread mainly in personal computers (PCs), and various USB compatible devices equipped with USB interfaces are marketed. In order to suppress power consumption due to an increase in communication speed, the USB 3.0 and later standards specify that communication is performed using normal data signals and LFPS (Low Frequency Periodic Signaling) signals. Normal data signals are binary digital signals that are 5 Gbps or more, and LFPS signals are ternary signals, which are signals that are 10 to 55 MHz and periodically repeat “1” and “0” and an electrically idle state. Since the method disclosed in Patent Literature 1 assumes binary digital signal transmission, it is difficult to perform communication by directly applying the method to LFPS signals, which are ternary.

As a technique for coping with such a problem, a technique of a transmission apparatus for wirelessly transmitting two types of signals, normal data signals and LFPS signals, is described in Japanese Patent Laid-Open No. 2016-72790 (hereinafter, Patent Literature 2).

The transmission apparatus disclosed in Patent Literature 2 has a configuration comprising two detection units for detecting each of the normal data signals and LFPS signals, and an output control unit for controlling the output of output signals based on the results of detection by the two detection units. Thus, in Patent Literature 2, two detection units and an output control unit are required in order to transmit two types of signals, the normal data signal and LFPS signals, so the configuration is complex. Therefore, there is a problem that the circuit scale is increased in order to transmit the two types of signals.

### SUMMARY OF THE INVENTION

The present invention provides a technique that enables transmission of a plurality of types of signals with a simple apparatus configuration.

According to one aspect of the present invention, there is provided a wireless communication system operable to transmit a signal using an electric field coupling that is caused by a transmission coupler provided in a first apparatus being arranged close to a reception coupler provided in a second apparatus, wherein the second apparatus has a reception circuit that is connected to the reception coupler, and the reception circuit, in a case where a coupling capacitance between the transmission coupler and the reception coupler is C and a basic angular frequency of the signal is ω, has a termination resistor that is larger than 10/ωC.

According to another aspect of the present invention, there is provided a reception apparatus comprising: a reception coupler configured to receive a signal using an electric field coupling that is caused by being arranged close to a transmission coupler that is provided in a transmission apparatus; and a reception circuit connected to the reception coupler, wherein the reception circuit, in a case where a coupling capacitance between the transmission coupler and the reception coupler is C and a basic angular frequency of the signal is ω, has a termination resistor that is larger than 10/ωC.

Further features of the present invention will become apparent from the following description of exemplary embodiments with reference to the attached drawings.

### BRIEF DESCRIPTION OF THE DRAWINGS

FIGS. 1A to 1C are diagrams illustrating examples of a configuration of a wireless communication system.

FIGS. 2A and 2B are diagrams illustrating examples of a configuration a first reception circuit (High-Z differential amplifier circuit).

FIGS. 3A to 3C are diagrams illustrating simulation results (at the time of transmission of a 10 MHz LFPS signal).

FIGS. 4A and 4B are diagrams illustrating simulation results (at the time of transmission of a 5 Gbps data signal).

FIGS. 5A to 5C are diagrams illustrating a function of correcting voltage amplitude on a low frequency band side.

FIG. 6 is a diagram illustrating an example of a configuration of another wireless communication system.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

### (Configuration of Wireless Communication System)

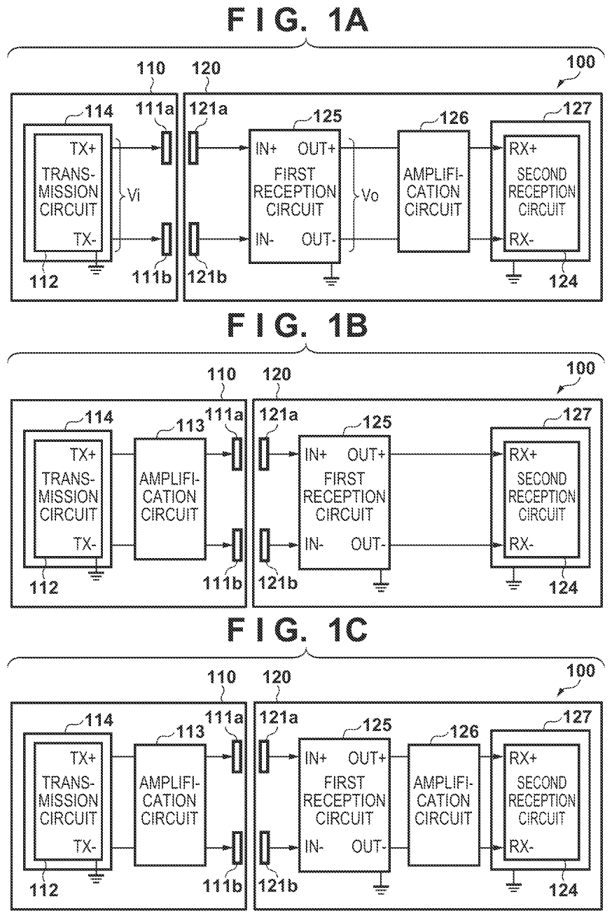

FIGS. 1A to 1C illustrate examples of a configuration of a wireless communication system 100 according to the present embodiment. The wireless communication system 100 is configured by a first communication module 110 and a second communication module 120.

The first communication module 110 in the wireless communication system 100 illustrated in FIG. 1A has transmission couplers 111a and 111b and a transmission circuit 112, and the second communication module 120 has reception couplers 121a and 121b, a first reception circuit (High-Z differential reception circuit) 125, an amplification circuit (AMP) 126, and a second reception circuit 124. Note that in the following description, there are cases where the transmission couplers 111a and 111b are collectively referred to as transmission couplers 111, and the reception couplers 121a and 121b are collectively referred to as reception couplers 121.

In the present embodiment, each communication module has two couplers configured by two separated conductors from the viewpoint of transmitting differential signals. Coupler patterns are, for example, patterns such as a rigid substrate or a flexible substrate and are formed by processing sheet metal, an MID (Molded Interconnect Device; molded circuit components), or the like. The transmission couplers 111 of the first communication module 110 and the reception couplers 121 of the second communication module 120 are coupled via electric field coupling by being arranged to face and be close to each other. The wireless communication system 100 realizes wireless communication (transmission of signals) between the first communication module 110 and the second communication module 120 using this electric field coupling.

The transmission circuit 112 is provided in a transceiver IC (Integrated Circuit) 114, and has a function of performing a waveform shaping on signals that were inputted from a device such as a PC (Personal Computer) via a transmission medium such as a USB cable so as to satisfy the USB 3.0 standard and outputting these. Note that the transceiver IC 114 is sometimes referred to as a redriver or the like, and is not limited to a particular configuration as long as it can transmit and receive signals whose waveforms are in a range defined by the USB 3.0 or later standard. Also, the second reception circuit 124 is provided in a transceiver IC 127, and has a function of receiving wirelessly transmitted analog signals, performing a waveform shaping on these so as to satisfy the USB 3.0 standard, and outputting these as a digital signal via a transmission medium such as a USB cable or a substrate to a device such as a camera. Note that the transceiver IC 127 is also sometimes referred to as a redriver or the like, and similarly to the transceiver IC 114, is not limited to a particular configuration as long as it can transmit and receive signals whose waveforms are specified by the USB 3.0 or a later standard.

FIG. 1B and FIG. IC illustrate variations of the wireless communication system 100 illustrated in FIG. 1A. In FIG. 1A, an example of a configuration in which the amplification circuit 126 is provided in the second communication module 120 is illustrated, but in FIG. 1B, a configuration in which an amplification circuit 113 is provided on the first communication module 110 side rather than the second communication module 120 is illustrated. FIG. 1C illustrates a configuration in which the amplification circuit 113 and the amplification circuit 126 are provided in the first communication module 110 and the second communication module 120, respectively. The reason for providing the amplification circuits, as will be described later, is so that the voltage amplitude of a low frequency LFPS signal will be a predetermined value or more (fall in the range of voltages specified by the standard).

(Principles of LFPS Signal Transmission)

Next, the principles by which the wireless communication modules illustrated in FIGS. 1A to 1C can transmit ternary LFPS (Low Frequency Periodic Signaling) signals will be described. The description will be given below using the wireless communication system 100 illustrated in FIG. 1A. First, a brief description of LFPS signals will be given. The signals generated in the transmission circuit 112 are ternary, where there is “idle” (indicating an electrically idle state) in addition to “1” and “0”. In the USB 3.0 standard, Polling.LFPS and Ping.LFPS specify that a period in which a burst-like clock signal is outputted and an “idle” period (state) in which nothing is outputted are periodically repeated.

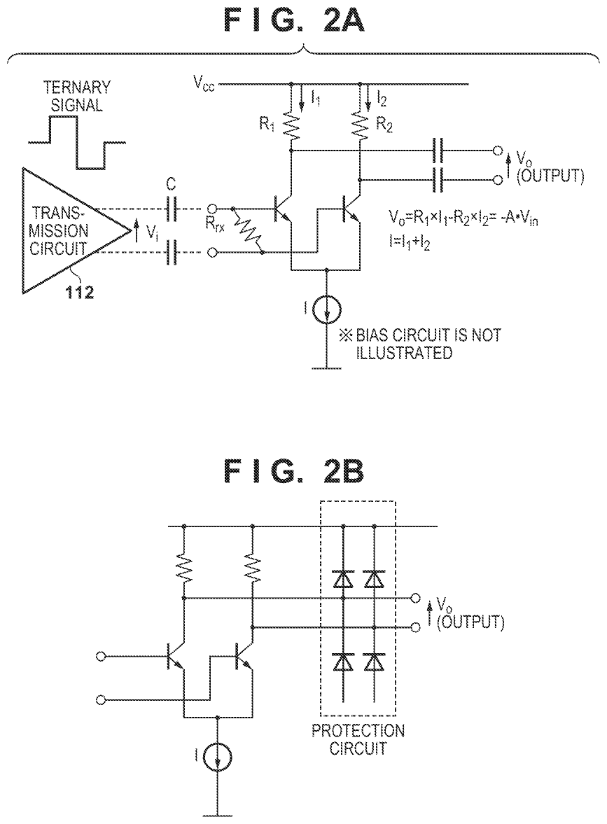

FIG. 2A illustrates the configuration of the first reception circuit 125 in the wireless communication system 100 illustrated in FIG. 1A. The flow of signal transmission of LFPS signals is as follows. A signal of either “1” or “0” is generated in the transmission circuit 112 and is transmitted to the transmission couplers 111. The signal is transmitted to the reception couplers 121 via coupling between the couplers, and then is inputted to the first reception circuit 125.

At this time, if the impedance of the first reception circuit 125 is 50Ω, the impedance of the capacitance component generated by the coupling between the transmission couplers 111 and the reception couplers 121 will be smaller in the low frequency band and larger in the high frequency band compared to the input impedance 100Ω of the first reception circuit 125 (50Ω×2). Therefore, the output wavefoini of the reception couplers 121 is a differential waveform where only high frequencies have passed. That is, since “0” or “1” becomes “0+idle” or “1+idle”, accurate transmission becomes difficult.

In order to accurately transmit ternary signals, the configuration described in Patent Literature 2 is also conceivable, but as described above, the configuration has a large circuit scale. Therefore, in the present embodiment, a termination resistor Rrx connected between the input teiminals of the first reception circuit 125 is controlled in order to receive LFPS signals and 5 Gbps data signals in the same circuit. Specifically, when the coupling capacitance between the transmission couplers 111 and the reception couplers 121 is C, the termination resistor Rrx illustrated in FIG. 2A is set to be 10/ΩC or more. Here, co is a basic angular frequency of a signal (baseband signal to be transmitted), and is Ω=2.5 GHz in this example. By selecting the input impedance of the reception circuit as described above, i.e., by connecting the termination resistor Rrx, which is 10/ΩC or more, as in FIG. 2A, an appropriate input impedance is realized, and miniaturization of the circuit scale and simplification can be realized. Note that the input impedance is a parallel impedance of the input impedance of the reception circuit and the termination resistor Rrx to be precise, but the input impedance of the reception circuit is sufficiently higher than the termination resistor Rrx, so in effect, the input impedance is determined by the termination resistor Rrx.

(Configuration of the Differential Reception Circuit)

FIGS. 2A and 2B illustrate examples of the first reception circuit 125 in the present embodiment. The first reception circuit 125 illustrated in FIGS. 2A and 2B is a differential amplifier circuit. The two input terminals of the first reception circuit 125 are connected to the reception couplers 121a and 121b, respectively, and the resistor Rrx is connected between the terminals. Note that a DC potential is supplied from the bias circuit (not illustrated) to the two input terminals of the first reception circuit 125. Further, a resistor element or the like may be inserted between the input terminals of the first reception circuit 125 and the reception couplers 121a and 121b. In a differential amplifier circuit, current flows to a load resistor connected to the collector side in accordance with the potential difference between the differential input terminals, and an output voltage is generated. Accordingly, since the first reception circuit 125 is an inverting amplifier circuit, it is necessary to exchange the output of the inverting terminal and the non-inverting terminal, but since there is no potential difference between the differential pairs at the time of idle, ternary transmission is possible.

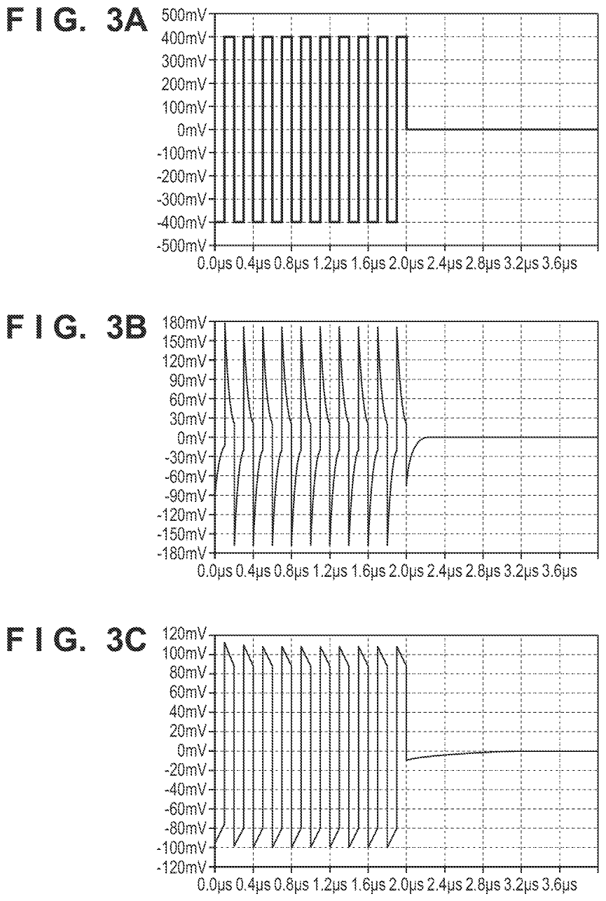

FIGS. 3A to 3C illustrate simulation results in the present embodiment. Specifically, FIGS. 3A to 3C illustrate waveforms at the respective measurement points at the time of transmission of a 10 MHz LFPS signal when the coupling capacitance between the couplers is 0.22 pF, the coupling capacitance between the transmission couplers 111a and 111b is 0.35 pF, and the coupling capacitance between the reception couplers 121a and 121b is also 0.35 pF. FIG. 3A illustrates a voltage signal Vi inputted to the transmission couplers Iii, and FIG. 3B illustrates an output voltage signal Vo when the input impedance of the first reception circuit 125 is 100 kΩ. Further, FIG. 3C illustrates a waveform of the output voltage signal Vo when the input impedance of the first reception circuit 125 is 1 MΩ. In FIG. 3B, the output voltage signal Vo is a differential waveform, and therefore, LFPS signals cannot be transmitted correctly. On the other hand, in FIG. 3C, the output voltage signal Vo is a rectangular wave, and therefore, LFPS signals can be transmitted correctly. By comparing the waveforms of the voltage signals of FIG. 3B and FIG. 3C, it can be seen that ternary transmission is possible if the input impedance of the first reception circuit 125 is sufficiently high with respect to the 10 MHz LFPS signal.

Note that although a differential amplifier circuit as illustrated in FIGS. 2A and 2B was indicated as an example of the first reception circuit 125, the present invention is not particularly limited to a differential amplifier circuit, and it is also possible to use a collector grounding circuit called an emitter follower circuit and the like, for example.

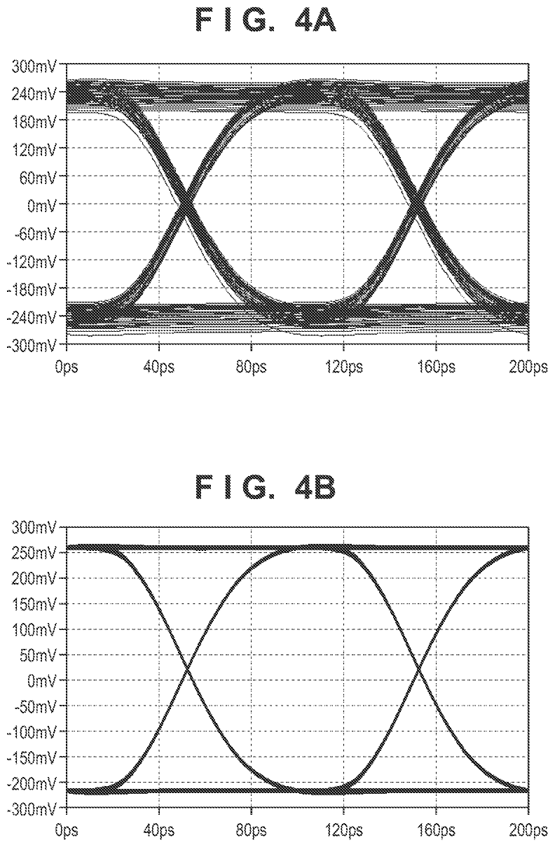

The flow of transmission of 5 Gbps data signals is the same as that of LFPS signals. FIGS. 4A and 4B illustrate simulation results of an eye pattern at the time of transmission of a 5 Gbps data signal. FIG. 4A illustrates an eye pattern when the input impedance of the first reception circuit 125 is 10 kΩ, and FIG. 4B illustrates an eye pattern when the input impedance of the first reception circuit 125 is 1 MΩ. From FIGS. 4A and 4B, it can be seen that although there is a degradation in the waveform when the input impedance of the first reception circuit 125 is 10 kΩ as compared to when it is 1 MΩ, sufficient eye opening is obtained even at about 10 kΩ.

Thus, the following can be seen from the simulation results of FIGS. 3A to 3C and FIGS. 4A and 4B.

(1) To receive a 10 MHz LFPS signal, it is preferred that the input impedance is about 1 MΩ or more.

(2) To receive a 5 Gbps data signal, it is preferred that the input impedance is about 10 kΩ or more.

Therefore, it can be seen that two types of signals, 5 Gbps digital signals and ternary LFPS signals that are 10 to 50 MHz, can be transmitted wirelessly using a configuration in which the termination resistor Rrx (>10/ωC) having a resistance value that realizes the input impedance of (1) and (2) described above is connected.

Note that in the examples of FIGS. 3A to 3C, the coupling capacitance between the couplers is 0.22 pF, but when the mounting area of the couplers and the distance between the couplers needs to be increased, the signal amplitude decreases. In the USB 3.0 standard, the voltage amplitudes of LFPS signals need to be 300 mVpp or more, so the output signals need to be amplified. Therefore, as illustrated in the wireless communication system 100 of FIGS. 1A to 1C, the voltage amplitude can be amplified to a level that satisfies the standard by providing an amplification circuit in the reception (FIG. 1A), the transmission (FIG. 1B), or both the transmission and reception (FIG. 1C). By providing an amplifier for the LFPS frequencies as described above, both 5 Gbps data signals and LFPS signals can be communicated more reliably.

Even if the input impedance of the first reception circuit 125 can be made to be sufficiently high with respect to the impedance due to the coupling capacitance between the couplers at a frequency of 10 to 50 MHz, the voltage amplitude of LFPS signal to be outputted falls below 300 mVpp as illustrated in FIG. 3C. When using the wireless communication system 100 illustrated in FIG. lA as an example, it is also preferred to amplify the signal amplitude in the amplification circuit 126 as previously described in order to maintain 300 mVpp or more for 10 to 50 MHz. However, when the voltage tolerance of the input terminals of the amplification circuit 126 and the transceiver IC 127 that are connected after the first reception circuit 125 is low, protection diodes (protection circuit) may be provided at the output of the first reception circuit 125. FIG. 2B illustrates an example in which protection diodes are provided at the output of the first reception circuit 125. Thus, by providing protection diodes, by setting the current to which the current source of FIG. 2A is set such that the output cannot output more than 20% of 300 mVpp, and the like, it is possible to alleviate the amount of spike (spike voltage).

[First Variation]

As described above, it has been found that the wavefouirs of the output voltages are different between when the input impedance of the first reception circuit 125 is 100 kΩ and 1 MΩ. That is, comparing FIG. 3B and FIG. 3C, it was found that LFPS signals cannot be accurately received when the input impedance of the first reception circuit 125 is 10 kΩ. Further, from FIGS. 4A and 4B, it was found that in the transmission of 5 Gbps data signals, although there is a degradation in the waveform when the input impedance of the first reception circuit 125 is 10 kΩ (FIG. 4A) as compared to when it is 1 MΩ (FIG. 4B), sufficient eye opening is obtained even at about 10 kΩ.

Thus, at the time of transmission of LFPS signals and at the time of transmission of 5 Gbps data signals, there is a gap in the input impedance required for the first reception circuit 125. In other words, the first reception circuit 125 is sufficient so long as it can receive LFPS signals that are 10 to 50 MHz with an impedance of about 1 MΩ, and in the 200 to 5 GHz band required for transmission of 5 Gbps data signals, perform reception with an impedance of about 10 kΩ. The reason is that since capacitive coupling between the couplers behaves like a high-pass filter, making it difficult for low frequency components to pass, reception must be performed with a higher impedance, but high-frequency components can easily pass, and therefore relatively low impedance is sufficient.

In view of this, the input impedance of the first reception circuit 125 may be configured to have a frequency characteristic. Generally, it is difficult to ensure an impedance of about 1 MΩ uniformly on an FR4 substrate for frequencies up to 5 GHz. However, it is possible to achieve an impedance of about 1 MΩ for low frequencies that are about 10 to 50 MHz. Thus, changing the input impedance of the first reception circuit 125 in accordance with the frequency of the signal received by the reception couplers 121 is suitable as a means of realizing LFPS signals that are 10 to 50 MHz and 5 Gbps data signals in the same couplers and circuits, and the structure can be simplified.

[Second Variation]

Instead of changing the input impedance of the first reception circuit 125 in accordance with the frequency as in the first variation, the same effect can be obtained by performing correction to increase the voltage amplitude on the low frequency band side. The correction can be realized by each circuit unit such as a transmission side amplification circuit 113, the reception side amplification circuit 126, and the like.

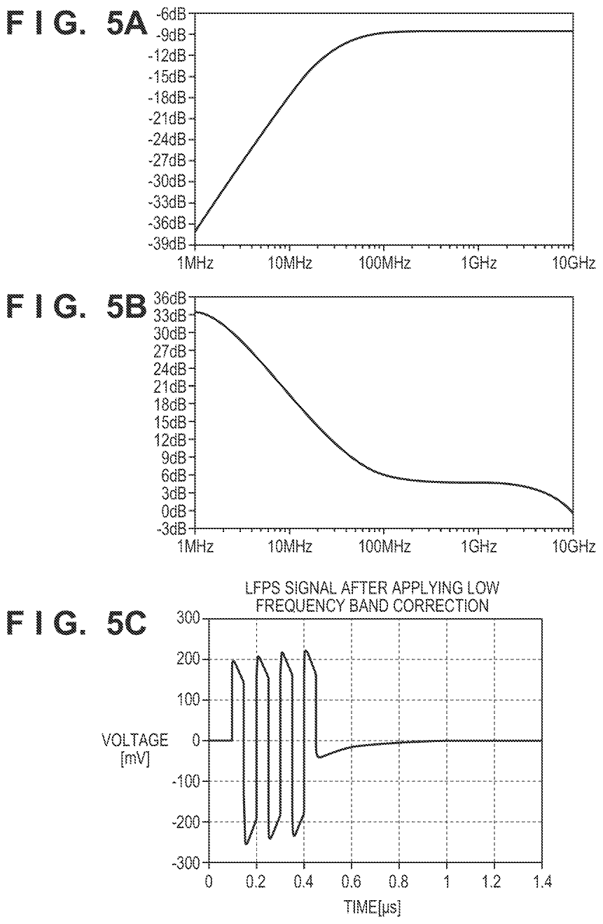

The correction function will be described with reference to FIGS. 5A to 5C. FIG. 5A illustrates the frequency characteristic of the characteristic of transmission from the transmission circuit 112 to the first reception circuit 125 when the coupling capacitance between the couplers is 0.22 pF, the coupling capacitance between the transmission couplers 111a and 111b and the coupling capacitance between the reception couplers 121a and 121b are 0.35 pF, and the input impedance of the first reception circuit 125 is 10 kΩ. In FIG. 5A, it can be seen that the frequency band of 100 MHz or more can be transmitted almost flatly. However, at frequencies below 100 MHz, the gain drops almost linearly.

FIG. SB illustrates the frequency characteristic of the correction for the decrease in the gain illustrated in FIG. 5A, and has a characteristic of amplifying a signal in the frequency band of about 2 MHz to 100 MHz. By providing a correction circuit (such as the amplification circuit 126) having such a characteristic on the reception side, LFPS signals on the low frequency side that are 10 to 50 MHz among the received signal are accurately identified. That is, it becomes possible to reliably transmit low frequency LFPS signals that are 10 to 50 MHz, even at the time of setting impedance of the first reception circuit 125 in a range that can be realized in an FR4 substrate.

Note that such a function of correcting a low frequency band may be provided on the transmission side (i.e., correction for signals on the low frequency side among the signal to be transmitted by the amplification circuit 113 or the like), in which case, there is a merit such as noise resistance is improved.

[Third Variation]

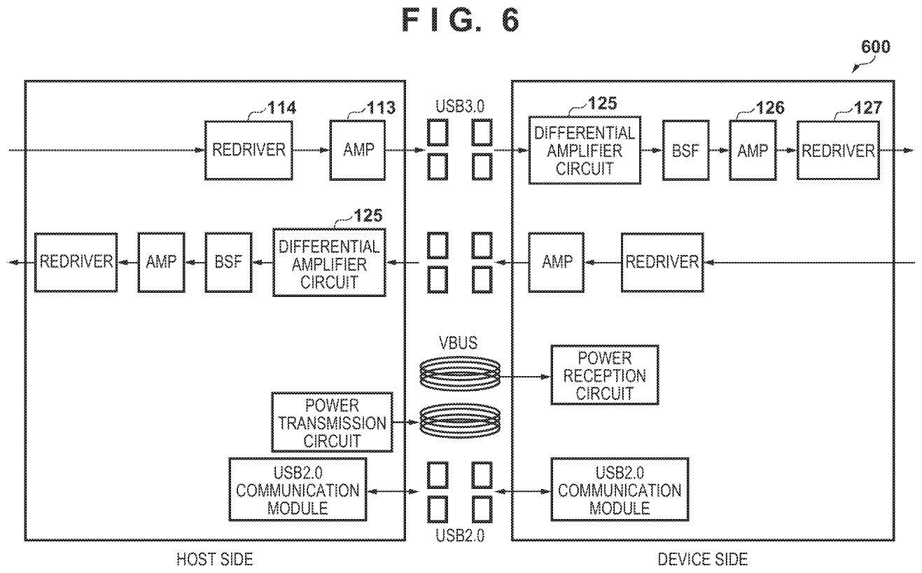

FIG. 6 illustrates an example of a configuration of a wireless communication system 600 in a third variation. In the wireless communication system 600, it is possible to realize a wireless configuration of USB 3.0 with a simple configuration. When the device side is not equipped with a battery or the like and needs a supply of power, it is possible to supply power such as VBUS from the host side in a non-contact manner. In that case, since there is a possibility of being subjected to electromagnetic interference from the non-contact power transmission, it is also possible to realize a more reliable wireless communication system by avoiding interference using a filter for the carrier frequency of the non-contact power transmission, for example, a high-pass filter (HPF), a bandstop filter (BSF), or the like. It is also possible to ensure backward compatibility by using a wireless module for USB 2.0 as well.

### Other Embodiments

The wireless communication systems in the above embodiments have been described as wireless communication systems for transmitting a differential baseband signal, but are not limited thereto and may be wireless communication systems for transmitting a single signal.

Also, the wireless communication systems in the above embodiments are systems in which adaptation to the USB 3.0 and later standards is envisioned, but the above wireless communication systems can be applied not only to USBs but also to systems that use ternary signals. For example, the above-described wireless communication systems can be applied to systems that use Serial ATA (SATA) signals.

Further, the wireless communication systems described above can make a USB cable for connecting a personal computer and an electronic device wireless, and can be applied to USB communication between, for example, a personal computer and a camera or a personal computer and a printer.

As described above, according to the above embodiments, it is possible to provide a wireless communication system capable of transmitting a plurality of types of signals with a simple configuration and in a size that can be implemented in small-sized products or small-scale production facilities.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-170032, filed Oct. 7, 2020, which is hereby incorporated by reference herein in its entirety.

What is claimed is:

1. A wireless communication system operable to transmit a signal using an electric field coupling that is caused by a transmission coupler provided in a first apparatus being arranged close to a reception coupler provided in a second apparatus, wherein
the second apparatus has a reception circuit that is connected to the reception coupler, and
the reception circuit, in a case where a coupling capacitance between the transmission coupler and the reception coupler is C and a basic angular frequency of the signal is co, has a termination resistor that is larger than 10/ωC.

2. The system according to claim 1, wherein
the second apparatus has a redriver that is connected to the reception circuit, and
the redriver performs a waveform shaping on a signal that is outputted from the reception circuit and outputs it from the second apparatus.

3. The system according to claim 1, wherein
the second apparatus has an amplification circuit that is connected to the reception circuit and a redriver that is connected to the amplification circuit, and
the amplification circuit amplifies a voltage amplitude of a signal to be outputted from the reception circuit, and the redriver performs a waveform shaping of the signal whose voltage amplitude has been amplified and outputs it from the second apparatus.

4. The system according to claim 3, wherein the amplification circuit amplifies a voltage amplitude of a signal on a low frequency side among frequencies of a signal that is outputted from the reception circuit.

5. The system according to claim 2, wherein the reception circuit is further configured to alleviate a spike voltage of a signal to be outputted.

6. The system according to claim 5, wherein the reception circuit is configured such that an input impedance of the reception circuit changes in accordance with a frequency of a signal that is received by the reception coupler.

7. The system according to claim 1, wherein the first apparatus has a transmission side amplification circuit that is connected to the transmission coupler, and the transmission side amplification circuit amplifies a voltage amplitude of a signal on a low frequency side among frequencies of a signal to be transmitted.

8. The system according to claim 1, wherein the reception circuit is a differential amplifier circuit.

9. The system according to claim 1, wherein the first apparatus and the second apparatus transmit and receive a signal that is specified by USB 3.0 and later standards.

10. The system according to claim 1, wherein the first apparatus and the second apparatus transmit and receive a signal that is specified by a Serial ATA standard.

11. A reception apparatus comprising:
a reception coupler configured to receive a signal using an electric field coupling that is caused by being arranged close to a transmission coupler that is provided in a transmission apparatus; and
a reception circuit connected to the reception coupler, wherein
the reception circuit, in a case where a coupling capacitance between the transmission coupler and the reception coupler is C and a basic angular frequency of the signal is ω, has a termination resistor that is larger than 10/ωC.
